(19) United States
(12) Patent Application Publication
(10) Pub. No.: US 2024/0220639 A1
(43) Pub. Date: Jul. 4, 2024

(54) SECURE DATA OFFLOAD IN A DISAGGREGATED AND HETEROGENOUS ORCHESTRATION ENVIRONMENT

(71) Applicant: Intel Corporation, Santa Clara, CA (US)

(72) Inventors: Prateek Sahu, Austin, TX (US); Reshma Lal, Portland, OR (US)

(73) Assignee: Intel Corporation, Santa Clara, CA (US)

(21) Appl. No.: 18/148,576

(22) Filed: Dec. 30, 2022

(51) Int. Cl. G06F 21/60; G06F 21/57; G06F 21/85

(52) U.S. Cl. CPC G06F 21/602; G06F 21/57; G06F 21/85

(57) ABSTRACT

An apparatus comprises a compute complex comprising one or more processing resources to execute a software process, a hardware processor to initiate an authentication request to at least one adjunct processing hardware device communicatively coupled to the compute complex, establish a session key with the at least one adjunct processing hardware device, negotiate, with a hypervisor, a virtual function allocation for at least one virtual adjunct processing device to be implemented by the at least one adjunct processing hardware device to define a configuration in a trusted page table, verify the configuration with the at least one adjunct processing hardware device using the session key, and lock the configuration in the trusted table.

### BACKGROUND

Existing microservice orchestration solutions run only on central processing units (CPUs) with applications that offload portions of workloads to physically and/or locally connected accelerator devices. As accelerator devices have matured into devices which act as peers to CPUs with integrated compute or with infrastructure processing unit (IPU) managed accelerators, devices are capable of hosting services independently with minimal components running on the IPU or the compute complex.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1A is a simplified block diagram of at least one embodiment of a computing environment, according to embodiments.

FIG. 1B is a simplified block diagram of at least one embodiment of a computing environment, according to embodiments.

FIG. 2 is a simplified block diagram of a compute cluster, according to embodiments.

FIG. 3 is a simplified block diagram of a compute cluster illustrating a threat model, according to embodiments.

FIG. 4 is a simplified block diagram of a security architecture, according to embodiments.

FIG. 5 is a flow diagram of operations in a method to implement secure data offloading a disaggregated and heterogenous orchestration environment, in accordance with some embodiments.

FIG. 6 is a flow diagram of operations in a method to implement secure data offloading a disaggregated and heterogenous orchestration environment, in accordance with some embodiments.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

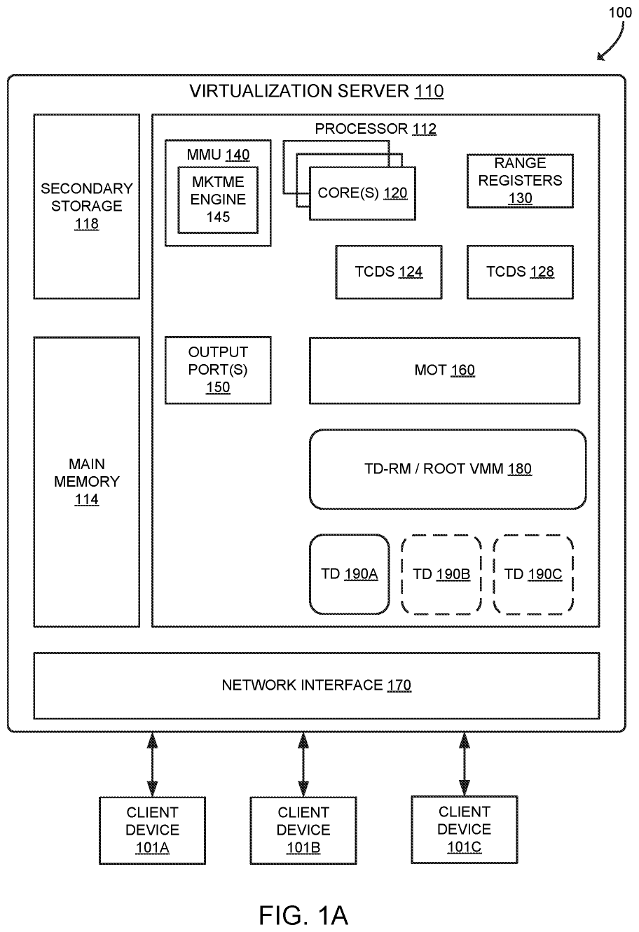

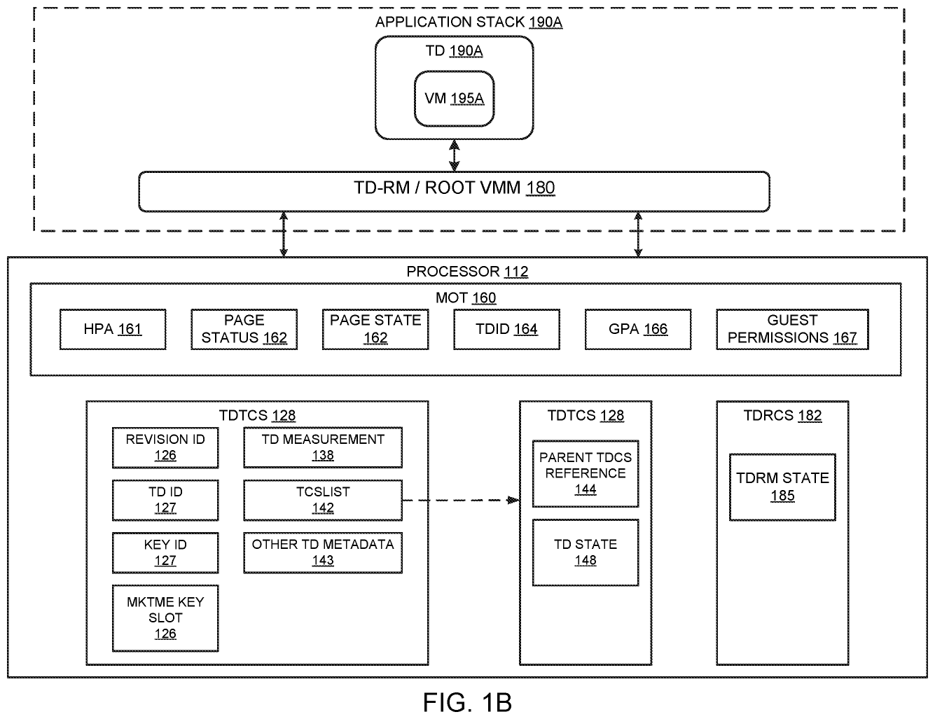

FIG. 1A is a block diagram illustrating an example computing system that provides isolation in virtualized systems using trust domains, in accordance with embodiments. The virtualization system 100 includes a virtualization server 110 that supports a number of client devices 101A-101C. The virtualization server 110 includes at least one processor 112 (also referred to as a processing device) that executes a trusted domain root of trust (TDRM) 180. The TDRM 180 may include a virtual machine manager (VMM) (which may also be referred to as hypervisor) that may instantiate one or more trusted domains (TDs) 190A-190C accessible by the client devices 101A-101C via a network interface 170. The client devices 101A-101C may include, but is not limited to, a desktop computer, a tablet computer, a laptop computer, a netbook, a notebook computer, a personal digital assistant (PDA), a server, a workstation, a cellular telephone, a mobile computing device, a smart phone, an Internet appliance or any other type of computing device.

A TD may refer to a tenant (e.g., customer) workload. The tenant workload can include an OS alone along with other ring-3 applications running on top of the operating system (OS) or can include a virtual machine (VM) running on top of a VMM along with other ring-3 applications, for example. In implementations of the disclosure, each TD may be cryptographically isolated in memory using a separate exclusive key for encrypting the memory (holding code and data) associated with the TD.

Processor 112 may include one or more cores 120 (also referred to as processing cores 120), range registers 130, a memory management unit (MMU) 140, and output port(s) 150. FIG. 1B is a schematic block diagram of a detailed view of a processor core 120 executing a TDRM 180 in communication with a MOT 160 and one or more trust domain control structure(s) (TDCS(s)) 124 and trust domain thread control structure(s) (TDTCS(s)) 128, as shown in FIG. 1A. TDTCS and TD-TCS may be used interchangeable herein. Processor 112 may be used in a system that includes, but is not limited to, a desktop computer, a tablet computer, a laptop computer, a netbook, a notebook computer, a personal digital assistant (PDA), a server, a workstation, a cellular telephone, a mobile computing device, a smart phone, an Internet appliance or any other type of computing device. In another implementation, processor 112 may be used in a system-on-chip (SoC) system.

The computing system 100 is representative of processing systems based on micro-processing devices available from Intel Corporation of Santa Clara, Calif., although other systems (including PCs having other micro-processing devices, engineering workstations, set-top boxes and the like) may also be used. In one implementation, sample system 100 executes a version of the WINDOWS™ operating system available from Microsoft Corporation of Redmond, Wash., although other operating systems (UNIX and Linux for example), embedded software, and/or graphical user interfaces, may also be used. Thus, implementations of the disclosure are not limited to any specific combination of hardware circuitry and software.

The one or more processing cores 120 execute instructions of the system. The processing core 120 includes, but is not limited to, pre-fetch logic to fetch instructions, decode logic to decode the instructions, execution logic to execute instructions and the like. In an implementation, the computing system 100 includes a component, such as the processor 112 to employ execution units including logic to perform algorithms for processing data.

The virtualization server 110 includes a main memory 114 and a secondary storage 118 to store program binaries and OS driver events. Data in the secondary storage 118 may be stored in blocks referred to as pages, and each page may correspond to a set of physical memory addresses. The virtualization server 110 may employ virtual memory management in which applications run by the core(s) 120, such as the TDs 190A-190C, use virtual memory addresses that are mapped to guest physical memory addresses, and guest physical memory addresses are mapped to host/system physical addresses by MMU 140.

The core 120 may execute the MMU 140 to load pages from the secondary storage 118 into the main memory 114 (which includes a volatile memory and/or a nonvolatile memory) for faster access by software running on the processor 112 (e.g., on the core). When one of the TDs 190A-190C attempts to access a virtual memory address that corresponds to a physical memory address of a page loaded into the main memory 114, the MMU 140 returns the requested data. The core 120 may execute the VMM portion of TDRM 180 to translate guest physical addresses to host physical addresses of main memory and provide parameters for a protocol that allows the core 120 to read, walk and interpret these mappings.

In one implementation, processor 112 implements a TD architecture and ISA extensions (TDX) for the TD architecture. The TD architecture provides isolation between TD workloads 190A-190C and from CSP software (e.g., TDRM 180 and/or a CSP VMM (e.g., root VMM 180)) executing on the processor 112). Components of the TD architecture can include 1) memory encryption via multi-key total memory encryption (MK-TME) engine 145, 2) a resource management capability referred to herein as the TDRM 180, and 3) execution state and memory isolation capabilities in the processor 112 provided via a MOT 160 and via access-controlled TD control structures (i.e., TDCS 124 and TDTCS 128). The TDX architecture provides an ability of the processor 112 to deploy TDs 190A-190C that leverage the MK-TME engine 145, the MOT 160, and the access-controlled TD control structures (i.e., TDCS 124 and TDTCS 128) for secure operation of TD workloads 190A-190C.

In implementations of the disclosure, the TDRM 180 acts as a host and has full control of the cores 120 and other platform hardware. A TDRM 180 assigns software in a TD 190A-190C with logical processor(s). The TDRM 180, however, cannot access a TD's 190A-190C execution state on the assigned logical processor(s). Similarly, a TDRM 180 assigns physical memory and I/O resources to the TDs 190A-190C, but is not privy to access the memory state of a TD 190A due to separate encryption keys, and other integrity and replay controls on memory.

With respect to the separate encryption keys, the processor may utilize the MK-TME engine 145 to encrypt (and decrypt) memory used during execution. With total memory encryption (TME), any memory accesses by software executing on the core 120 can be encrypted in memory with an encryption key. MK-TME is an enhancement to TME that allows use of multiple encryption keys (the number of supported keys is implementation dependent). The processor 112 may utilize the MKTME engine 145 to cause different pages to be encrypted using different MK-TME keys. The MK-TME engine 145 may be utilized in the TD architecture described herein to support one or more encryption keys per each TD 190A-190C to help achieve the cryptographic isolation between different CSP customer workloads. For example, when MK-TME engine 145 is used in the TD architecture, the CPU enforces by default that TD (all pages) are to be encrypted using a TD-specific key. Furthermore, a TD may further choose specific TD pages to be plain text or encrypted using different ephemeral keys that are opaque to CSP software.

Each TD 190A-190C is a software environment that supports a software stack consisting of VMMs (e.g., using virtual machine extensions (VMX)), OSes, and/or application software (hosted by the OS). Each TD 190A-190C operates independently of other TDs 190A-190C and uses logical processor(s), memory, and I/O assigned by the TDRM 180 on the platform. Software executing in a TD 190A-190C operates with reduced privileges so that the TDRM 180 can retain control of platform resources; however, the TDRM cannot affect the confidentiality or integrity of the TD 190A-190C under defined circumstances. Further details of the TD architecture and TDX are described in more detail below with reference to FIG. 1B.

Implementations of the disclosure are not limited to computer systems. Alternative implementations of the disclosure can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processing device (DSP), system on a chip, network computers (NetPC), set-top boxes, network hubs, wide area network (WAN) switches, or any other system that can perform one or more instructions in accordance with at least one implementation.

One implementation may be described in the context of a single processing device desktop or server system, but alternative implementations may be included in a multiprocessing device system. Computing system 100 may be an example of a ‘hub’ system architecture. The computing system 100 includes a processor 112 to process data signals. The processor 112, as one illustrative example, includes a complex instruction set computer (CISC) micro-processing device, a reduced instruction set computing (RISC) micro-processing device, a very long instruction word (VLIW) micro-processing device, a processing device implementing a combination of instruction sets, or any other processing device, such as a digital signal processing device, for example. The processor 112 is coupled to a processing device bus that transmits data signals between the processor 112 and other components in the computing system 100, such as main memory 114 and/or secondary storage 118, storing instruction, data, or any combination thereof. The other components of the computing system 100 may include a graphics accelerator, a memory controller hub, an I/O controller hub, a wireless transceiver, a Flash BIOS, a network controller, an audio controller, a serial expansion port, an I/O controller, etc. These elements perform their conventional functions that are well known to those familiar with the art.

In one implementation, processor 112 includes a Level 1 (L1) internal cache memory. Depending on the architecture, the processor 112 may have a single internal cache or multiple levels of internal caches. Other implementations include a combination of both internal and external caches depending on the particular implementation and needs. A register file is to store different types of data in various registers including integer registers, floating point registers, vector registers, banked registers, shadow registers, checkpoint registers, status registers, configuration registers, and instruction pointer register.

It should be noted that the execution unit may or may not have a floating point unit. The processor 112, in one implementation, includes a microcode (ucode) ROM to store microcode, which when executed, is to perform algorithms for certain macroinstructions or handle complex scenarios. Here, microcode is potentially updateable to handle logic bugs/fixes for processor 112.

Alternate implementations of an execution unit may also be used in micro controllers, embedded processing devices, graphics devices, DSPs, and other types of logic circuits. System 100 includes a main memory 114 (may also be referred to as memory 114). Main memory 114 includes a DRAM device, a static random-access memory (SRAM) device, flash memory device, or other memory device. Main memory 114 stores instructions and/or data represented by data signals that are to be executed by the processor 112. The processor 112 is coupled to the main memory 114 via a processing device bus. A system logic chip, such as a memory controller hub (MCH) may be coupled to the processing device bus and main memory 114. An MCH can provide a high bandwidth memory path to main memory 114 for instruction and data storage and for storage of graphics commands, data and textures. The MCH can be used to direct data signals between the processor 112, main memory 114, and other components in the system 100 and to bridge the data signals between processing device bus, memory 114, and system I/O, for example. The MCH may be coupled to memory 114 through a memory interface. In some implementations, the system logic chip can provide a graphics port for coupling to a graphics controller through an Accelerated Graphics Port (AGP) interconnect.

The computing system 100 may also include an I/O controller hub (ICH). The ICH can provide direct connections to some I/O devices via a local I/O bus. The local I/O bus is a high-speed I/O bus for connecting peripherals to the memory 114, chipset, and processor 112. Some examples are the audio controller, firmware hub (flash BIOS), wireless transceiver, data storage, legacy I/O controller containing user input and keyboard interfaces, a serial expansion port such as Universal Serial Bus (USB), and a network controller. The data storage device can comprise a hard disk drive, a floppy disk drive, a CD-ROM device, a flash memory device, or other mass storage device.

For another implementation of a system, the instructions executed by the processing device core 120 described above can be used with a system on a chip. One implementation of a system on a chip comprises of a processing device and a memory. The memory for one such system is a flash memory. The flash memory can be located on the same die as the processing device and other system components. Additionally, other logic blocks such as a memory controller or graphics controller can also be located on a system on a chip.

With reference to FIG. 1B, this figure depicts a block diagram of the processor 112 of FIG. 1A, according to one implementation of the disclosure. In one implementation, the processor 112 may execute an application stack 101 via a single core 120 or across several cores 120. As discussed above, the processor 112 may provide a TD architecture and TDX to provide confidentiality (and integrity) for customer software running in the customer/tenants (i.e., TDs 190A) in an untrusted cloud service providers (CSP) infrastructure. The TD architecture provides for memory isolation via a MOT 160; CPU state isolation that incorporates CPU key management via TDCS 124 and/or TDTCS 128; and CPU measurement infrastructure for TD 190A software.

In one implementation, TD architecture provides ISA extensions (referred to as TDX) that support confidential operation of OS and OS-managed applications (virtualized and non-virtualized). A platform, such as one including processor 112, with TDX enabled can function as multiple encrypted contexts referred to as TDs. For case of explanation, a single TD 190A is depicted in FIG. 1B. Each TD 190A can run VMMs, VMs, OSes, and/or applications. For example, TD 190A is depicted as hosting VM 195A.

In one implementation, the TDRM 180 may include as part of VMM functionality (e.g., root VMM). A VMM may refer to software, firmware, or hardware to create, run, and manage a virtual machines (VM), such as VM 195A. It should be noted that the VMM may create, run, and manage one or more VMs. As depicted, the VMM 110 is included as a component of one or more processing cores 120 of a processing device 122. The VMM 110 may create and run the VM 195A and allocate one or more virtual processors (e.g., vCPUs) to the VM 195A. The VM 195A may be referred to as guest 195A herein. The VMM may allow the VM 195A to access hardware of the underlying computing system, such as computing system 100 of FIG. 1A. The VM 195A may execute a guest operating system (OS). The VMM may manage the execution of the guest OS. The guest OS may function to control access of virtual processors of the VM 195A to underlying hardware and software resources of the computing system 100. It should be noted that, when there are numerous VMs 195A operating on the processing device 112, the VMM may manage each of the guest OSes executing on the numerous guests. In some implementations, a VMM may be implemented with the TD 190A to manage the VMs 195A. This VMM may be referred to as a tenant VMM and/or a non-root VMM and is discussed in further detail below.

TDX also provides a programming interface for a TD management layer of the TD architecture referred to as the TDRM 180. A TDRM may be implemented as part of the CSP/root VMM. The TDRM 180 manages the operation of TDs 190A. While a TDRM 180 can assign and manage resources, such as CPU, memory and input/output (I/O) to TDs 190A, the TDRM 180 is designed to operate outside of a TCB of the TDs 190A. The TCB of a system refers to a set of hardware, firmware, and/or software component that have an ability to influence the trust for the overall operation of the system.

In one implementation, the TD architecture is thus a capability to protect software running in a TD 190A. As discussed above, components of the TD architecture may include 1) Memory encryption via a TME engine having Multi-key extensions to TME (e.g., MK-TME engine 145 of FIG. 1A), 2) a software resource management layer (TDRM 180), and 3) execution state and memory isolation capabilities in the TD architecture.

Kubernetes is an example of an orchestration system for containers to automate the process of application deployment, scaling, and management. A Kubernetes cluster consists of a set of worker machines, called nodes, that host the containerized applications inside pods and a control plane that manages the worker nodes and the pods in the cluster. Application pods are deployed on available resources in a pool of compute nodes.

Key components of a control plane in Kubernetes include a centralized application programing interface (API) server, an orchestrator, a scheduler, and a broker which primarily controls the management and deployment of the containers. Node agents including a kubelet, and proxy services that run on the worker nodes. A kubelet manages available resources on node and pod deployment while a proxy manages routing to enable microservices to communicate with each other and with external client nodes.

Kubernetes orchestration platforms provide the framework for basic security plumbing in microservice architectures. For example, Kubernetes includes a mutual transport layer security (mTLS) service that provides secure inter-service and intra-service communication between application microservices. A role-based access control (RBAC) provides fundamental authentication and authorization primitives, e.g., single sign on-user Azure directory (SSO/AD). Secure device plugins allow Kubernetes to use trusted execution environment (TEE) features, e.g., software guard extensions (SGX), secure encrypted virtualization (SEV), Graphene, etc., to deploy containers. Marblerun Allows to attest deployment configuration and provides secure execution of application inside SGX. Marblerun attempts to strike a balance between performance and security by reducing the number of running containers per application. Marblerun achieves this by packaging some of the sidecar features like mutual transport layer security (mTLS) with the application itself and running this container within SGX TEEs.

Each of these security features suffers from certain limitations. For example, mutual transport layer security (mTLS) features are usually provided as a feature in a networking sidecar that coordinates with a centralized trusted certificate authority (CA) to provision transport layer security (TLS) certificates to the sidecar agents and to provide validation of the same. This secures the communication between service sidecars but still leaves the data in plain text to be communicated between the sidecar and the application container. Any malicious container which can access the pod namespace can snoop on the data and it places implicit trust on the host operating system or hypervisor and the Kubernetes administrator.

Role based access control (RBAC) also places trust on host operating system or hypervisor and the Kubernetes administrator, which is not always a trusted party and can be easily circumvented by a skilled attacker. Secure Device Plugins like SGX allow confidential deployment of containers using minimally trusted library operating systems (e.g., Graphene/Occulum), but it brings in a significant communication overhead when put every container inside a trusted execution environment (TEE). It also does not address secure communication with an accelerator resource. In trying to package sidecar features within an application, Marblerun inhibits rapid feature development since the entire application needs to be rebuilt for every networking feature, which inhibits an effective implementation of a service mesh model. Also, Marblerun also does not address any hardware accelerator microservice offload in its security analysis.

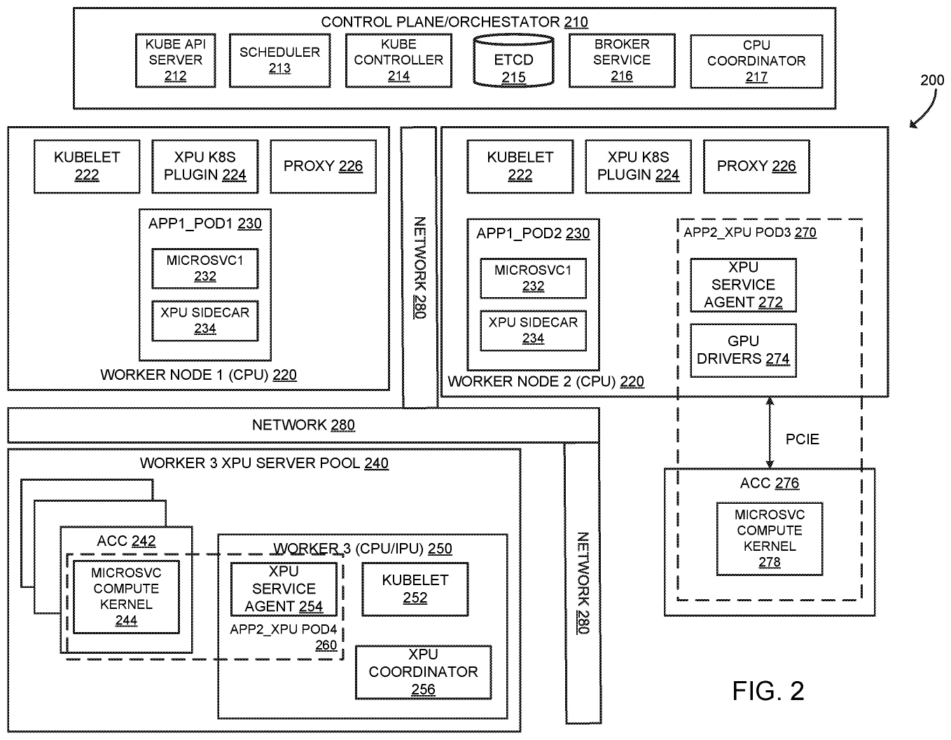

To address these and other issues, subject matter described herein provides verifiable service configuration and host confidential computing workloads. In some examples technologies like trusted domain extension (TDX) and trusted input/output (TDXIO) solutions may be leveraged to provide a secure communication framework and still uphold the scalability and dynamic requirements of microservices. Additional features and techniques will be explained below with reference to FIGS. 2-FIG. 7.

There are three key players involved in a Kubernetes manage solution. The first is the Kubernetes infrastructure administrator, typically an information technology (IT) group or a compute service provider (CSP) entity. The second is a developer, which develops one or more services and deploys them on a Kubernetes managed system. The third is the client, which may be an application that wants to use microservices for a task such as image recognition, analytics, etc.

FIG. 2 is a simplified block diagram of a compute cluster 200, according to embodiments. Referring to FIG. 2, in some examples a Kubernetes orchestration framework comprises a control plane orchestrator 210, one or more worker nodes 220, and a worker server pool 240 communicatively coupled by a network 280. In some examples the control plane comprises a Kube application programming interface (API) server 212, a scheduler 213, a Kube controller 214, an ETCD database 215, a broker service 216, and a CPU coordinator 217, all running on a master node. The respective worker nodes 220 comprise a kubelet agent 222, an XPU plugin 224, and a proxy 226. Each worker node may comprise an application pod 230, which in turn may comprise one or more microservices 232, and an XPU sidecar 234. Worker node 2 220 comprises an XPU service agent 272, one or more graphics processing unit (GPU) drivers 274 communicatively coupled to hardware accelerator e.g. GPU, FPGA [Acc stood for accelerator] 242, which comprises a microservice compute kernel 278. Worker 3 server pool 240 comprises pool of accelerators 242 which also comprises a microservice compute kernel 244 and a central processing unit (CPU) or an infrastructure processing unit (IPU) 250 which, in turn, comprises a kubelet agent 252, an XPU service agent 254 and an XPU coordinator 256. Microservice computer kernel 244 and XPU service agent 254 cooperate to define a XPU pod 260. The respective elements of the compute cluster 200 are communicatively coupled via a network 280.

These control plane components form the intelligence of the compute cluster 200 and are responsible for deployment of applications and for configuration of services topologies to form an end-to-end application. The API server 212 provides an interface for developers to define an application topology and resource requirements in the form of a manifest file which is then deployed on worker nodes with the help of kubelet agents 222. The kubelet agents 222 report back health of pods (e.g., pod 230, 260, 270) and available resources of a worker node 220 to the API server 212, which is used by the controller 214 and scheduler 213 to appropriately schedule application pods 230 on the worker nodes 220.

In some examples, the kubelet agent 222 interacts with container runtimes to hand off the appropriate manifest files and the container runtime takes control of actual application microservice deployments. The control plane 210 also interacts with kube-proxy 226 and appropriate container networking interface modules to setup the routing table rules and domain name service (DNS) appropriately for microservices to be able to communicate in the cluster over a protocol such as transmission control protocol/internet protocol (TCP/IP). As described herein, the Kubernetes architecture may be extended by adding components to support independent hardware microservice deployments on remote, disaggregated accelerators. In some examples, the components added comprise a broker service 216, an XPU coordinator 256, one or more XPU service agents 254, 272, and one or more XPU sidecars 234.

Remoting runtime is a ring-3 runtime component that resides above the user mode drivers and the GPU/XPU kernel mode drivers. Each XPU agent pod 230 interacted with the common runtime which in turn communicated with the host operating system and drivers for device management and allocation of devices to the XPU agent pods 230. In addition to device management and resource reporting, the runtime also includes features like batching of commands, and helps select/configure transport layer such configuring a network interface card (NIC) for remote direct memory access (RDMA) transfer directly to the memory of an accelerator such as a graphics processing unit (GPU).

In some examples the runtime functionality may be divided into an arbitrator logic which handles the device management and allocation of accelerator resources such as GPUs and/or GPU slices to one or more of the XPU agent pods 230 and a separate runtime which continues to include features like batching and configuration of a network interface card (NIC) for remote direct memory access (RDMA). This split facilitates establishing a trusted virtual machine and/or domain model to meet confidential computing needs and the XPU Agents 230 inside the trusted domain (e.g., one trusted domain per XPU agent microservice instance) interface with a common trusted module for secure allocation and management of available accelerators such as graphics processing units (GPUs) for various services. This process is managed by the XPU coordinator 256, which is hosted in a separate trusted domain and is part of the trusted computing base. In some examples, the XPU coordinator 256 may be provided by the XPU vendor or compute service provider (CSP) and has authentication measurements to provide its authenticity and integrity. Additional functionalities of runtime may be managed by the remoting runtime service, which may execute inside the XPU agent 254 trusted domain (it is deployed once per agent). This split reduces the footprint of the trusted compute base (TCB) in the coordinator trusted domain (TD).

In some examples the broker service 216 is part of the central control plane 210 which manages the available accelerator resources in the cluster and allocates and/or schedules accelerators based on deployment manifest which is defined by the developer and is associated with a service.

In some examples the XPU coordinator 256 is a control plane service component that resides in the XPU server pool and which interfaces with the operating system drivers and/or hypervisor to manage remote and local devices, allocate device resources, verifies configuration and provides a unified attestation quote of the HW microservices on behalf of an application. The XPU coordinator 256 is trusted software component which runs inside a trusted domain extension (TDX) environment The XPU coordinator 256 provides an interface for all XPU service agents 256 to receive XPU device slices and/or handles.

In some examples the XPU service agent 254 is a data-plane component that is deployed as part of a hardware microservice on the compute complex of the XPU server pool 240. An XPU server comprises one or more of XPUs along with a general-purpose compute complex and a network interface card (NIC), The compute complex and network interface card (NIC) unit can be discrete entities such as a Xeon and a traditional network interface card (NIC) or it can be an infrastructure processing unit (IPU) or a data processing unit (DPU) which has compute and network interface card (NIC) integrated in a unitary system on chip (SoC). The XPU service agent 254 container connects with the allocated accelerator resources via the remoting runtime and configures the accelerator device with the compute kernel and other command buffers to serve the hardware microservice. This also acts as the interface for the rest of the application microservices to communicate with the hardware microservice via a standard application programming interface (API) such as google remote procedure calls (gRPC) for control messages and setting up remote data offload.

In some examples, the acceleration sidecar 234 is another data-plane component that is deployed alongside all application microservices. The acceleration sidecar 234 may be implemented as a bump-in-the-wire level four (L4) filter that detects payloads to and from its associated application microservice intended for a hardware microservice. The acceleration sidecar 234 also houses intelligence and driver support to support data transfer to local and/or remote accelerators transparently. The acceleration sidecar 234 manages remote direct memory access (RDMA) buffer setup for such packets in tandem with the XPU service agent 254 and informs the XPU service agent 254 to start the memcpy. In this example, the acceleration sidecar sets up source and destination buffers on the Network Interface Card (NIC) of the worker node 1 (220) and sends a TCP packet to XPU service agent 254 to do the same on the NIC associated with XPU Server 240. Once setup, acceleration sidecar (234) copies its data intended for the hardware microservice into its source buffers and informs the XPU Service Agent 254 to initiate copy into its NIC's destination buffers via RDMA protocols. Similar procedure is followed to copy data back from hardware microservice to the acceleration sidecar.

In some examples an intelligent attacker that can leverage software bugs to mount a privileged escalation attack and may obtain administrative access onto a host operating system (OS) and/or hypervisors on both the central process unit (CPU) and one or more XPU servers in the XPU server pool 240. Further, a malicious Kubernetes administrator and/or a compromised Kubernetes application programming interface (API) server 212 can attempt to modify system topology after application deployments. Other tenants running services on the central processing unit (CPU) or the accelerator devices cannot bet trusted, nor can the network interface card (NIC) or other interfaces since they can be physically probed to compromise data confidentiality.

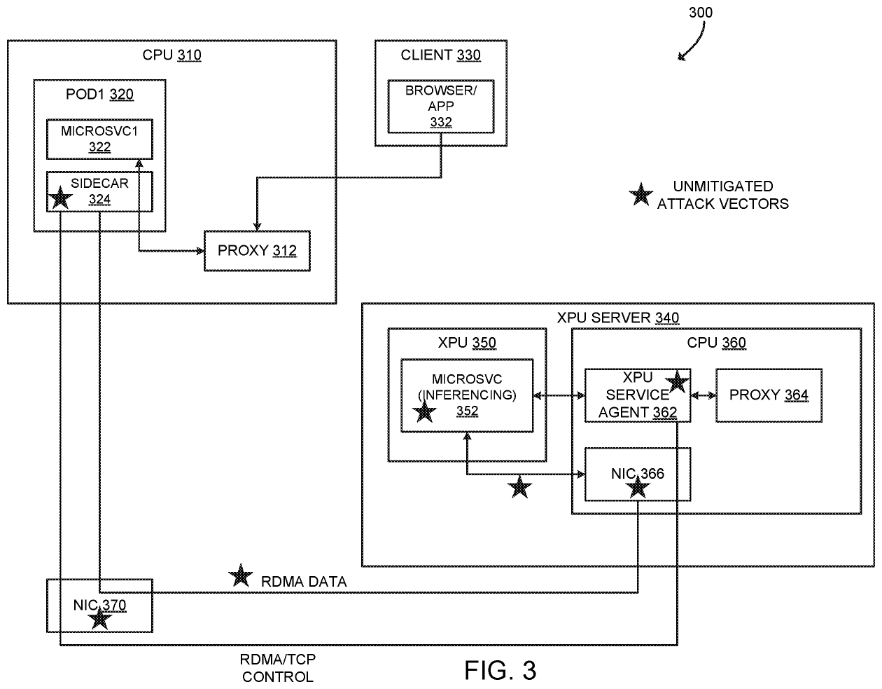

FIG. 3 is a simplified block diagram of a components of a compute cluster 300 illustrating a threat model, according to embodiments. Referring to FIG. 3, in some examples cluster 300 may comprise a client 330, a central processing unit (CPU) 310, one or more XPU servers 340, and one or more network interface cards 370. In some examples the CPU central processing unit (CPU) 310 may comprise a proxy 312 and an application pod 320 which, in turn, comprises a microservice 322 and a microservice sidecar 324. XPU server 340 may comprise one or more XPUs 350 which may comprise a microservice 352, and a central processing unit 360 which may comprise an XPU service agent 362, a proxy 364, and a network interface card 366.

Current security solutions protect portions of the data path. For example, transport layer security (TLS) and/or secure sockets layer (SSL) to protect client a user request, software guard extension (SGX) device plugins protect central processing unit (CPU) microservice application logic and memory, and mutual transport layer security (mTLS) for intra-service communications.

Trusted devices may include trust application logic, vendor specified device drivers such as network interface card (NIC) drivers and XPU drivers and guest operating system (OS) running in a virtual machine (VM) inside a hardware enforced trusted enclave (e.g., a Trusted Domain Execution and/or Confidential Compute containers). Accelerator device firmware (e.g., security engines) and the central processing unit (CPU) microcode may also be trusted.

Additional trusted devices may include the acceleration sidecar(s) 324, remoting runtime, XPU service agents 362 in our trusted compute base (TCB). Various techniques like static binary inspection and runtime signature verification that can be used to attest these components to be not malicious.

Available threat and/or attack surfaces in a Kubernetes cluster 300 are indicated with a black star and data flows are depicted for user logic and data. In some examples a Kubernetes administrator may configure the cluster 300 and control plane components in the cluster 300 including discovery, routing, and others. The developer may setup a microservice application such as a browser application 332 and initialize a compute device such as a central processing unit (CPU) 310 and one or more hardware accelerators such as XPU 350 to run the appropriate microservice. The browser application 332 may access the microservice 322 via a proxy 312.

In some examples a client 330 may execute an application such as a browser 332 which utilizes an application programming interface (API) service to perform a function such as inferencing. The client 330 that may use one or more microservices 322 running on central processing units (CPUs) 310 and hardware accelerators such as an XPU 350 running on an XPU server 340 that comprises an inference microservice 352 to complete the function. The client 330 may have sensitive input data and output data that must be protected by protecting execution, storage and control and data planes.

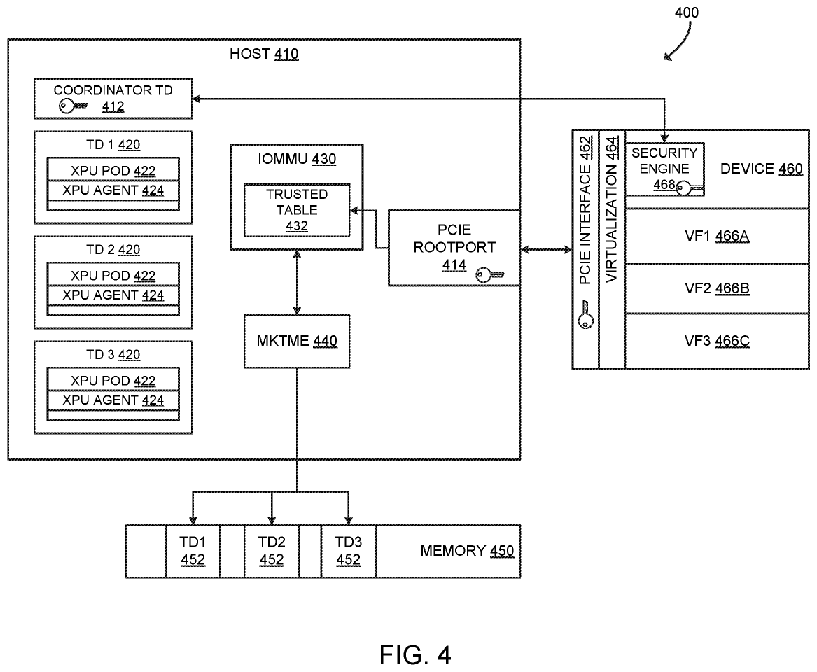

Components and operations of a security architecture 400 will be explained with reference to FIGS. 4-7. Referring first to FIG. 4, the security architecture 400 is illustrated with a host device 410 communicatively coupled to a computer readable memory 450 and a remote device 460. Host device 410 comprises a coordinator trusted domain 412, one or more trusted domains 420 for XPU devices, a peripheral component interconnect express (PCIe) rootport 414, an input/output memory management unit 430 and an encryption engine such as a multi-key total memory encryption (MKTME) engine 440. Each trusted domain 420 comprises an XPU pod 422 and an XPU agent 424. The input/output memory management unit (IOMMU) 430 maintains a trusted table 432.

Memory 450 comprise a trusted domains 452 that are associated with each of the respective trusted domains 420. Device 460 may be embodied as an accelerator device (e.g., an XPU) and comprises a PCIe interface 462, a virtualization engine 464 that allocates the resources of device 460 to multiple virtual functions 466A, 466B, 466C, and a security engine 468.

Using virtualization support on accelerator hardware (e.g., GPUs), customers can use single-root input/output virtualization (SR-IOV) techniques to spatially partition XPU resources and memory into software isolated domains which are available to the host operating system and/or hypervisor as virtual functions (VFs). The hypervisor then allocates these virtual functions to specific host applications or virtual machines for use by the respective virtual machines and/or applications to use the XPU resource. This allows for direct memory access (DMA) of the application memory by the XPU. These features of single-root input/output virtualization (SR-IOV) may be utilized to partition XPU resources in an accelerator pool and allocate them to various XPU Agents (per hardware microservice), as illustrated in FIG. 4.

As described above, the hypervisor is not trusted. Hence, the hypervisor may maliciously (or inadvertently) change the memory mapping and/or virtual function allocation to a malicious application which can threaten the confidentiality of the microservice. To mitigate this threat, the XPU coordinator 412 runs inside a trusted virtual machine enclave to arbitrates the XPU resources to various microservice XPU pods 230, 260, 270 (i.e., negotiates VF allocation to XPU agents) and verifies that the allocation is correctly configured by the untrusted hypervisor.

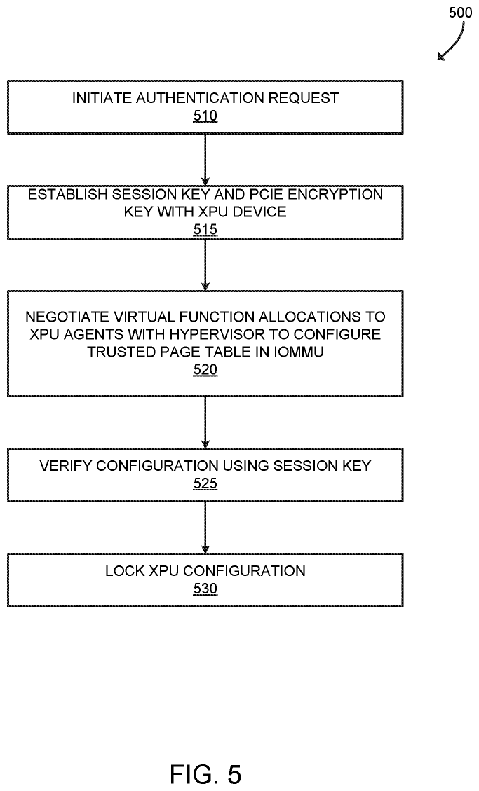

Operations implemented by the XPU coordinator 412 to configure components illustrated in FIG. 4 are presented in FIG. 5. Referring to FIG. 5, at operation 510 the XPU coordinator 412 initiates an authentication request for the XPU device 460. In some examples the request may be implemented as a security protocol and data model (SPDM) request. At operation 515 the XPU coordinator 412 establishes a session key with the XPU device 460, and more particularly with the security engine 468 of the XPU device 460. At operation 520 the XPU coordinator 412 negotiates virtual function allocations for the respective XPU agents with the hypervisor to configure the trusted page table in the input/output memory management unit (IOMMU) 430. At operation 525 the XPU coordinator 412 verifies the configuration using the session key. The XPU Coordinator is a privileged and trusted component that may read the trusted table to verify the configuration. At operation 530 the XPU coordinator 412 locks the configuration. As a part of TDXIO protocol, the security engine on the accelerator has a configuration bit that when set locks the device. In the event of any configuration change when this bit is set, the PCIe Rootport key is invalidated. We ensure that the trusted coordinator sets this bit before verifying the configuration and allowing access. Only the TD which sets the configuration can unset it.

Once the XPU device configuration is locked, only the XPU coordinator 412 can unlock it. Any malicious (or inadvertent) modifications and/or virtual function remapping by the hypervisor invalidates the link encryption key, which causes a denial-of-service error. Any direct memory access (DMA) request by an XPU partition follows a virtual function (VF) mapping in the trusted page table 432, which only allows the virtual function (VF) to view the protected trusted domain (TD) memory (i.e., the XPU agent's memory) to which it was assigned. All other requests are blocked at the translation operation of the input/output memory management unit (IOMMU) 430.

The encrypted trusted domain (TD) 452 memory is decrypted while leaving the memory 450, e.g., by MKTME engine 440, and re-encrypted using the link encryption keys before transfer to the XPU device 460 by the PCIe rootport 414. The data is routed from MKTME engine 440 to the PCIe rootport 414, but it may be sent over the SoC fabric which is trusted and is cannot be tampered by software. The PCIe interface 462 of the XPU device 460 decrypts the data and places it in the XPU memory's appropriate partition.

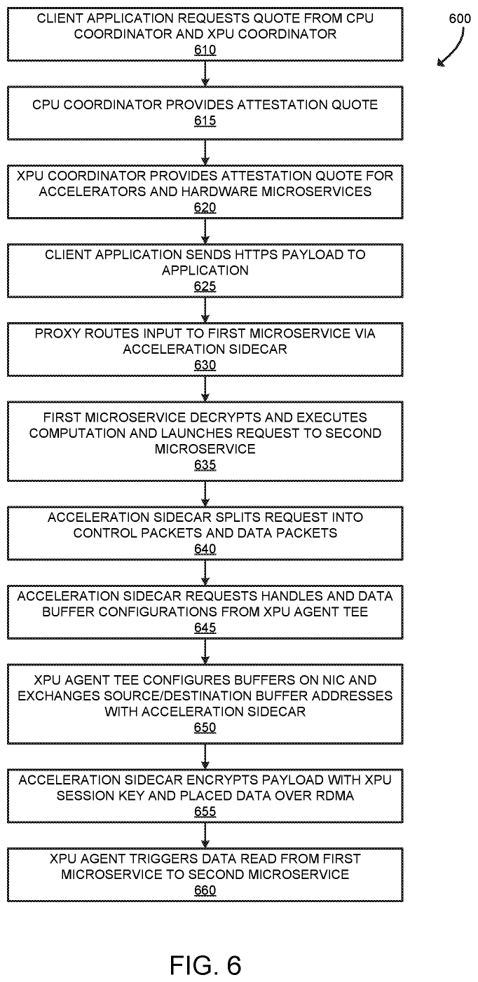

Operations implemented by various components to perform secure client request processing are presented in FIG. 6. Referring to FIG. 6, at operation 610a client application requests an attestation quote from the CPU 310 and the XPU coordinator 412. The CPU coordinator is a marblerun type coordinator that contains the manifest for the application and attests every running microservice trusted execution environment (TEE) to ensure that it is configured as per the manifest. It also acts as a root certificate authority (CA) for configuring mutual transport layer security (mTLS) keys. At operation 615 the CPU coordinator provides a concise quote attesting to the correctness of the microservice application to a client. Similarly, at operation 620 the XPU coordinator 256 attests the remote/local accelerators and the correct deployment of hardware microservices.

At operation 625 a client application (e.g., browser application 332) sends a secure hypertext transfer protocol (HTTPS) payload to the server application microservice (microservice 1 232), which is encrypted by at least one of a secure sockets layer (SSL) or transport layer service (TLS) to the application. For example, the client portion of an application, sends a request to the server portion of the application, which maybe multiple microservices running on cloud infrastructure.

At operation 630 the proxy 312 checks the configuration (routing tables) in the trusted table 432 to identify the service internet protocol (IP) addresses and routes the input via acceleration sidecar 324 to the first microservice of the application (e.g., microservice 1 232 in FIG. 2). At operation 645 the first microservice trusted execution environment (TEE) decrypts the encrypted payload inside the trusted environment, executes the computation, and launches a request for a second microservice.

At operation 640 the acceleration sidecar receives the request for the second microservice (which is an XPU hardware microservice) and splits it into control and data message packets. At operation 645, as part of the control signal messages, the acceleration sidecar 324 requests device handles, data buffers configurations from XPU agent trusted execution environment (TEE) over a transport protocol such as transmission control protocol (TCP) or Google remote procedure call (gRPC). Such requests are mutual transport layer security (mTLS) encrypted.

At operation 650 the XPU agent trusted execution environment (TEE) 362 utilizes the remoting runtime to configure buffers on the network interface card (NIC) and exchanges source and destination buffer addresses with the acceleration sidecar 324 over a mutual transport layer security (mTLS) encrypted link using a transport protocol such as transmission control protocol (TCP) or Google remote procedure call (gRPC). In some examples, the XPU agent 362 and/or remoting runtime communicates with XPU 350 securely over TDXIO to exchange command buffers and/or control signals. The XPU guidance services center (GSC) initializes new shared session keys using cryptography engines and shares it with the acceleration sidecar 324 via XPU agent 362. The acceleration sidecar 324 programs the network interface card (NIC) 370 with remote direct memory access (RDMA) addresses and XPU agent 362 does the same on the XPU server 340.

At operation 655 the acceleration sidecar 324 encrypts the payload with the shared XPU session key and places the data over RDMA source address and waits for completion. At operation 660 the XPU agent 362 triggers data read (memcpy) from the first microservice memory mem (which is the source address) to the second microservice memory (which is the destination address). The data is placed in encrypted XPU memory and is decrypted by the session key while processing the data and results are placed back to encrypted XPU memory using the session key.

Illustrative examples of the technologies disclosed herein are provided below. An embodiment of the technologies may include any one or more, and any combination of, the examples described below.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMS (Erasable Programmable Read Only Memories), EEPROMs (Electrically Erasable Programmable Read Only Memories), magnetic or optical cards, flash memory, or other type of media/machine-readable medium suitable for storing machine-executable instructions.

Some embodiments pertain to Example 1 that includes an apparatus comprising a compute complex comprising one or more processing resources to execute a software process; and a hardware processor to initiate an authentication request to at least one adjunct processing hardware device communicatively coupled to the compute complex; establish a session key with the at least one adjunct processing hardware device; negotiate, with a hypervisor, a virtual function allocation for at least one virtual adjunct processing device to be implemented by the at least one adjunct processing hardware device to define a configuration in a trusted page table; verify the configuration with the at least one adjunct processing hardware device using the session key; and lock the configuration in the trusted table.

Example 2 includes the subject matter of Example 1, the hardware processor to establish a peripheral component interconnect express (PCIe) encryption key with the at least one adjunct processing hardware device.

Example 3 includes the subject matter of Examples 1 and 2, further comprising a computer readable memory communicatively coupled to the hardware processor, and a multi-key total memory encryption (MKTME) to encrypt data written to the computer readable memory and to decrypt data read from the computer readable memory.

Example 4 includes the subject matter of Examples 1-3, the processor to the hardware processor to provide an attestation quote from a CPU in the compute complex; and provide an attestation quote from the at least one adjunct processing hardware device.

Example 5 includes the subject matter of Examples 1-4, the hardware processor to receive, from an application, a payload for a first microservice operation to be performed by a virtual function of the at least one adjunct processing hardware device; and route the payload to a first microservice.

Example 6 includes the subject matter of Examples 1-5, the hardware processor to execute the microservice operations in the first microservice operation to be performed by a virtual function of the at least one adjunct processing hardware device; and route the payload to a second microservice.

Example 7 includes the subject matter of Examples 1-6, wherein the payload is encrypted during transport from the first microservice to the second microservice.

Some embodiments pertain to Example 8 that includes a method comprising in a hardware processor initiating an authentication request to at least one adjunct processing hardware device communicatively coupled to a compute complex comprising one or more processing resources to execute a software process; establishing a session key with the at least one adjunct processing hardware device; negotiating, with a hypervisor, a virtual function allocation for at least one virtual adjunct processing device to be implemented by the at least one adjunct processing hardware device to define a configuration in a trusted page table; verifying the configuration with the at least one adjunct processing hardware device using the session key; and locking the configuration in the trusted table.

Example 9 includes the subject matter of Example 8, further comprising establishing a peripheral component interconnect express (PCIe) encryption key with the at least one adjunct processing hardware device.

Example 10 includes the subject matter of Examples 8 and 9, further comprising initiating a multi-key total memory encryption (MKTME) to encrypt data written to a computer readable memory communicatively coupled to the hardware processor and to decrypt data read from the computer readable memory.

Example 11 includes the subject matter of Examples 8-10, further comprising providing an attestation quote from a CPU in the compute complex; and providing an attestation quote from the at least one adjunct processing hardware device.

Example 12 includes the subject matter of Examples 8-11, further comprising receiving, from an application, a payload for a first microservice operation to be performed by a virtual function of the at least one adjunct processing hardware device; and routing the payload to a first microservice.

Example 13 includes the subject matter of Examples 8-12, further comprising executing the microservice operations in the first microservice operation to be performed by a virtual function of the at least one adjunct processing hardware device; and routing the payload to a second microservice.

Example 14 includes the subject matter of Examples 8-13, wherein the payload is encrypted during transport from the first microservice to the second microservice.

Some embodiments pertain to Example 15, that includes at least one non-transitory computer readable medium having instructions stored thereon, which when executed by a processor, cause the processor to initiate an authentication request to at least one adjunct processing hardware device communicatively coupled to a compute complex comprising one or more processing resources to execute a software process; establish a session key with the at least one adjunct processing hardware device; negotiate, with a hypervisor, a virtual function allocation for at least one virtual adjunct processing device to be implemented by the at least one adjunct processing hardware device to define a configuration in a trusted page table; verify the configuration with the at least one adjunct processing hardware device using the session key; and lock the configuration in the trusted table.

Example 16 includes the subject matter of Example 15, further comprising instructions stored thereon that, in response to being executed, cause the computing device to establish a peripheral component interconnect express (PCIe) encryption key with the at least one adjunct processing hardware device.

Example 17 includes the subject matter of Examples 15 and 16, further comprising instructions stored thereon that, in response to being executed, cause the computing device to initiate a multi-key total memory encryption (MKTME) to encrypt data written to a computer readable memory communicatively coupled to the hardware processor and to decrypt data read from the computer readable memory.

Example 18 includes the subject matter of Examples 15-17, further comprising instructions stored thereon that, in response to being executed, cause the computing device to provide an attestation quote from a CPU in the compute complex; and provide an attestation quote from the at least one adjunct processing hardware device.

Example 19 includes the subject matter of Examples 15-18, further comprising instructions stored thereon that, in response to being executed, cause the computing device to e from an application, a payload for a first microservice operation to be performed by a virtual function of the at least one adjunct processing hardware device; and route the payload to a first microservice.

Example 20 includes the subject matter of Examples 15-19, further comprising instructions stored thereon that, in response to being executed, cause the computing device to execute the microservice operations in the first microservice operation to be performed by a virtual function of the at least one adjunct processing hardware device; and route the payload to a second microservice.

Example 21 includes the subject matter of Examples 15-20, wherein the payload is encrypted during transport from the first microservice to the second microservice.

The details above have been provided with reference to specific embodiments. Persons skilled in the art, however, will understand that various modifications and changes may be made thereto without departing from the broader spirit and scope of any of the embodiments as set forth in the appended claims. The foregoing description and drawings are, accordingly, to be regarded in an illustrative rather than a restrictive sense.

What is claimed is:

1. An apparatus, comprising:
a compute complex comprising one or more processing resources to execute a software process; and
a hardware processor to:
initiate an authentication request to at least one adjunct processing hardware device communicatively coupled to the compute complex;
establish a session key with the at least one adjunct processing hardware device;
negotiate, with a hypervisor, a virtual function allocation for at least one virtual adjunct processing device to be implemented by the at least one adjunct processing hardware device to define a configuration in a trusted page table;
verify the configuration with the at least one adjunct processing hardware device using the session key; and
lock the configuration in the trusted table.

2. The apparatus of claim 1, the hardware processor to:
establish a peripheral component interconnect express (PCIe) encryption key with the at least one adjunct processing hardware device.

3. The apparatus of claim 1, further comprising:
a computer readable memory communicatively coupled to the hardware processor, and
a multi-key total memory encryption (MKTME) to encrypt data written to the computer readable memory and to decrypt data read from the computer readable memory.

4. The apparatus of claim 1, the hardware processor to:
provide an attestation quote from a CPU in the compute complex; and
provide an attestation quote from the at least one adjunct processing hardware device.

5. The apparatus of claim 1, the hardware processor to:
receive, from an application, a payload for a first microservice operation to be performed by a virtual function of the at least one adjunct processing hardware device; and
route the payload to a first microservice.

6. The apparatus of claim 5, the hardware processor to:
execute the microservice operations in the first microservice operation to be performed by a virtual function of the at least one adjunct processing hardware device; and
route the payload to a second microservice.

7. The apparatus of claim 6, wherein the payload is encrypted during transport from the first microservice to the second microservice.

8. A method, comprising:
in a hardware processor:
initiating an authentication request to at least one adjunct processing hardware device communicatively coupled to a compute complex comprising one or more processing resources to execute a software process;
establishing a session key with the at least one adjunct processing hardware device;
negotiating, with a hypervisor, a virtual function allocation for at least one virtual adjunct processing device to be implemented by the at least one adjunct processing hardware device hardware to define a configuration in a trusted page table;
verifying the configuration with the at least one adjunct processing hardware device using the session key; and
locking the configuration in the trusted table.

9. The method of claim 8, further comprising:
establishing a peripheral component interconnect express (PCIe) encryption key with the at least one adjunct processing hardware device.

10. The method of claim 8, further comprising:
initiating a multi-key total memory encryption (MKTME) to encrypt data written to a computer readable memory communicatively coupled to the hardware processor and to decrypt data read from the computer readable memory.

11. The method of claim 8, further comprising:
providing an attestation quote from a CPU in the compute complex; and
providing an attestation quote from the at least one adjunct processing hardware device.

12. The method of claim 8, further comprising:
receiving, from an application, a payload for a first microservice operation to be performed by a virtual function of the at least one adjunct processing hardware device; and
routing the payload to a first microservice.

13. The method of claim 8, further comprising:
executing the microservice operations in the first microservice operation to be performed by a virtual function of the at least one adjunct processing hardware device; and
routing the payload to a second microservice.

14. The method of claim 13, wherein the payload is encrypted during transport from the first microservice to the second microservice.

15. One or more non-transitory computer-readable storage media comprising instructions stored thereon that, in response to being executed, cause a computing device to:
initiate an authentication request to at least one adjunct processing hardware device communicatively coupled to a compute complex comprising one or more processing resources to execute a software process;
establish a session key with the at least one adjunct processing hardware device;
negotiate, with a hypervisor, a virtual function allocation for at least one virtual adjunct processing device to be implemented by the at least one adjunct processing hardware device hardware to define a configuration in a trusted page table;
verify the configuration with the at least one adjunct processing hardware device using the session key; and
lock the configuration in the trusted table.

16. The one or more non-transitory computer-readable storage media of claim 15, further comprising instructions stored thereon that, in response to being executed, cause the computing device to:
establish a peripheral component interconnect express (PCIe) encryption key with the at least one adjunct processing hardware device.

17. The one or more non-transitory computer-readable storage media of claim 15, further comprising instructions stored thereon that, in response to being executed, cause the computing device to:
initiate a multi-key total memory encryption (MKTME) to encrypt data written to a computer readable memory communicatively coupled to the hardware processor and to decrypt data read from the computer readable memory.

18. The one or more non-transitory computer-readable storage media of claim 15, further comprising instructions stored thereon that, in response to being executed, cause the computing device to:
provide an attestation quote from a CPU in the compute complex; and
provide an attestation quote from the at least one adjunct processing hardware device.

19. The one or more non-transitory computer-readable storage media of claim 15, further comprising instructions stored thereon that, in response to being executed, cause the computing device to:
receive, from an application, a payload for a first microservice operation to be performed by a virtual function of the at least one adjunct processing hardware device; and
route the payload to a first microservice.

20. The one or more non-transitory computer-readable storage media of claim 15, further comprising instructions stored thereon that, in response to being executed, cause the computing device to:
execute the microservice operations in the first microservice operation to be performed by a virtual function of the at least one adjunct processing hardware device; and
route the payload to a second microservice.

21. The one or more non-transitory computer-readable storage media of claim 20, wherein the payload is encrypted during transport from the first microservice to the second microservice.
